(19) United States
(12) Patent Application Publication
(10) Pub. No.: US 2011/0103080 A1
(43) Pub. Date: May 5, 2011

(54) ILLUMINATION ELEMENT HAVING A PLASTIC SUPPORT

(76) Inventor: Johannes Kalhoff, Blomberg (DE)

(21) Appl. No.: 13/000,160

(22) PCT Filed: Jun. 17, 2009
(86) PCT No.: PCT/EP09/04363

§ 371 Date: Dec. 20, 2010

(30) Foreign Application Priority Data
Jun. 18, 2008 (DE) 10 2008 028 611.7

(51) Int. Cl. F21V 29/00

(52) U.S. Cl. 362/382

(57) ABSTRACT

A lighting element including at least one light source, at least two connections, to supply electric current to the light source and a fixture to receive the light source. The light source includes a heat-generating section and the fixture contacts this heat-generating section, wherein the fixture consists of a thermally conductive plastic and is configured such that it dissipates the heat generated by the light source at least in part.

The present invention relates to a lighting element. A plurality of lighting elements has been known from the prior art. Other than light bulbs which have been in existence for a long time, light-emitting diodes (LEDs) are finding increasing acceptance as illuminants in particular in recent times. Compared to light bulbs for example, these light-emitting diodes are efficient in terms of energy consumption, they are smaller and generate less heat. In recent times engineers have been involved in developing LEDs having the brightness of standard illuminants.

These illuminants have already been known in directional building lighting and as driving lights for vehicles. However, no standardised solutions are known as yet for combining LED illuminants with standard lamp sockets. At this time only standardised sockets for conventional illuminants are on the market.

LED lighting elements are intended to be used in other ways as well in the future. For example so-called OLEDs (organic light emitting diodes) and other technologies are under development. It can further be expected that illumination as such will change drastically.

Other than present applications, directional lighting, area, mobile, and selected lighting (e.g. for atmospheric lighting) will expand the concept of lighting design. This will in turn have a direct impact on installation i.e. in particular on the dimensions, location, stability, and temperature, and contacting for selecting, i.e. on power connection.

The problem of efficient heat dissipation arises in particular in the case of assemblies having a plurality of light sources. Thus for example the dissipation out of the housing of any electronics-generated heat is intended to be improved.

It is therefore the object of the present invention to avoid or dispense with the presently used complicated heat sinks or at least to improve control of heat distribution.

The methods known thus far for generating light are usually coupled with generating high heat and the known illuminants start out from the fact that the illuminant and its socket absorbs high temperatures such that the light generating process must be robust as regards heat.

In the case of LEDs or similar methods, however, heat is generated in spots, influencing the light generating process and the service life per se. Furthermore, illuminants will be smaller in design in the future and other ways of utilization will be enabled as well. In this case the decisive factor will be the combination of a heat dissipation connection with design and styling.

In addition, electronic control devices will be incorporated as well which also emit heat, such as dimmers, colour-control elements, light control elements, etc.

These days most LED manufacturers are focused on the object of generating light from LEDs and to a lesser degree on cost-effectively manufacturing lamp sockets and the requirements of being able to dissipate to the ambience process heat from the LED which is a highly localised heat generation.

It is therefore in particular a further object of the present invention to provide a specific device which allows efficient heat dissipation in particular also when employing LEDs. It is thus intended to allow manufacturing lighting elements comprising a plurality of light sources.

According to the invention this is achieved by a lighting element having the features of claim 1 and by a fixture having the features of claim 11. Preferred embodiments and more specific embodiments are the objects of the subclaims. Further preferred features of the invention are indicated in the embodiments.

A lighting element according to the invention comprises at least one light source having two connections to supply the light source with electric current. Furthermore the lighting element comprises a fixture for receiving the light source. According to the invention the light source comprises a heat-generating section and the fixture contacts this heat-generating section wherein the fixture consists of or comprises a thermally conductive plastic and is configured such that it dissipates the heat generated by the light source at least in part.

Preferably such fixture is an injection-moulded part. Preferably this fixture or the plastic therefor is injected into a specific mould and a specific wiring technique is provided. This allows to manufacture industrialised illuminant sockets.

Thus, to solve the object described above a thermally conductive plastic is used or provided which takes up the generated heat at the source and dissipates it directly to the ambience or to a socket. Preferably this light source holding and cooling system is thus combined with a socket and in this form already represents a cooling device. In this way it is possible to dissipate highest heat outputs through the fixture or through a surrounding socket.

In all of the configurations and more specific embodiments it is preferred to employ thermally and/or electrically and/or magnetically conductive plastics with e.g. fine or very fine metal, steel, or stainless steel fibres incorporated into the plastic so as to obtain a compound making the finished product thermally and electrically conductive.

What is also particularly preferred is, employing spherical metal particles included in the plastic. Diameters in the range of micrometres are preferred.

The metals employed are preferably those having high thermal conductivity. For example employing copper or copper alloys is preferred. Metal fibres or metal particles virtually ideally serve as an efficient filler for thermally conductive plastics. Despite their small volume they may be entirely sufficient for considerably improving the thermal properties of the fixture.

Inclusions of copper, aluminium, and boron nitride or graphite are particularly preferred for increasing thermal conductivity. The proportion of additives or of filler is in particular in the range between approximately 10 and 70%, preferably between approximately 20 and 60%. With the addition of e.g. graphite particles or copper particles, the thermal conductivity is in particular higher than 1 W/(mK) and preferably higher than 2 W/(mK). Although the thermal conductivity is preferably in the range between approximately 2 W/(mK) and approximately 10 W/(mK), it may be higher still.

In all of the configurations the fixture of plastic may comprise a three-dimensional material structure such that other than electrically insulating portions, electrically conductive portions are provided as well which are equipped with conductive tracks. Manufacturing may be done e.g. by way of laser structuring. Subsequent galvanizing provides electric conductivity.

In the case of laser structuring, a laser may process and activate the metal nuclei on the plastic surface and comprised in the material. The metal is released and deposited on the surface. This allows to introduce fine and finest circuit patterns into the material by way of lasering. The actual conductive tracks may be generated in a copper bath following thereafter since the metals from the copper bath are deposited where the laser has released the metal.

On the whole this allows manufacturing an anisotropic structure which enables preferred directions of heat conduction and wherein intended electrical connections can be manufactured.

The light source is preferably a light-emitting diode or an OLED.

In another advantageous embodiment the fixture surrounds the light source entirely or substantially entirely in a peripheral direction. In this way the generated heat development can be dissipated in every direction. It is thus possible for the fixture to comprise an opening in which the LED or at least its heat-generating section is inserted.

In another advantageous embodiment the lighting element comprises a socket surrounding the fixture. It is for example possible for the fixture to comprise a thread which can be threaded into this socket. Plug-in sockets and the like are conceivable as well. In this way generated heat may be dissipated through the socket as well.

In another advantageous embodiment at least one connection comprises an electrically conductive plastic. Thus it might for example be possible to incorporate the connection in the fixture.

In another advantageous embodiment the fixture consists of an electrically conductive plastic at least in part. Thus the electrical contacting of the light source with energy supply can be incorporated into the design of the illuminant and the fixture as an electrically conductive plastic. In this way the electrical connection presently occurs preferably via the incorporated conductive plastic.

The fixture of the light source and the socket may preferably be optimised by at least one electrically and thermally conductive plastic.

As an alternative to thermally conductive plastics, other materials having thermal properties can be used, such as ceramic and metal. In another advantageous embodiment the lighting element comprises another cooling device surrounding the fixture. Preferably this further cooling device also surrounds the socket indicated above. This allows a still more efficient dissipation of heat output which is significant in particular in the case that multiple light sources are arranged in one carrier.

In another advantageous embodiment the lighting element comprises printed conductive tracks. Also, electrically conductive properties may be applied by means of galvanic processes.

According to still another advantageous embodiment the lighting element comprises a plurality of light sources. These light sources may for example be arranged side by side or else in an array or in the plane of a ring and the like.

In an advantageous more specific embodiment of the invention the lighting element comprises a plurality of fixtures which can be joined together at their outer walls wherein first outer walls of these fixtures comprise a first profile and second outer walls of these fixtures comprise a second profile and the first profile and the second profile are configured to complement one another. In this way it is possible to join together a plurality of fixtures in the way of jigsaw puzzle pieces. Corresponding conductive tracks may be printed, laminated, pressed on, integrated into the surface, configured as a polymer, or the like.

The present invention is furthermore directed at a fixture for a light source comprising a receiving recess to receive a heat-generating section of a light source wherein the fixture consists of a thermally conductive plastic and is configured such that it dissipates the heat generated by the light source at least in part.

An embodiment of the invention is illustrated in the figures purely schematically and will be described in more detail below.

The figures show in:

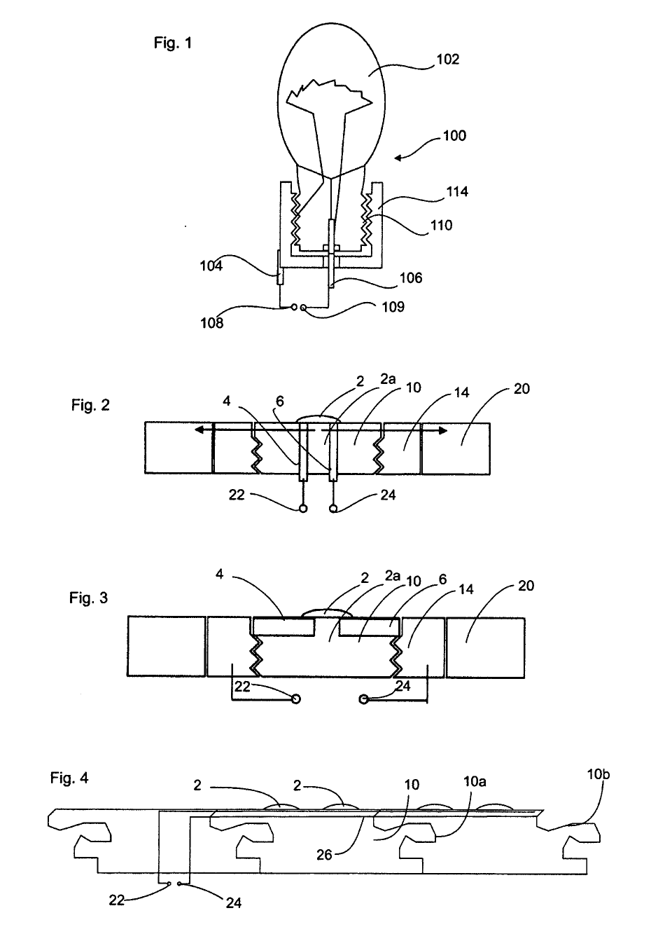

FIG. 1 a prior art lighting element;

FIG. 2 an inventive lighting element in a first embodiment;

FIG. 3 an inventive lighting element in a second embodiment in a plurality of lighting element; and

FIG. 4 an inventive lighting element in a third embodiment.

With reference to the FIGS. 1 to 4 three embodiments of a lighting element 100 according to the invention will be discussed below.

FIG. 1 shows a lighting element 100 in the shape of a light bulb in the prior art. The reference numeral 102 relates to the actual light source i.e. usually the glass envelope with the filament.

The reference numeral 110 relates to a fixture in which the light source 102 is retained wherein such fixture 110 also has the power supply for the light source 102 arranged inside.

The fixture 110 in turn is inserted in a socket 114 by way of a screw thread. The reference numerals 104 and 106 relate to two connections or contacts to supply current to the illuminant via electrical connections 108 and 109.

It can be seen that heat development with this illuminant is substantially generated at the light source per se and it can at least not be dissipated directly to the socket. Thus in the case of this light bulb the socket 114 does not serve for cooling it and it must be capable of withstanding high temperatures.

FIG. 2 shows an inventive lighting element 1. This lighting element 1 comprises a light source 2 in the shape of a light-emitting diode which is supplied with current via two connections 4 and 6. Heat is generated in the region 2a of the light source.

The reference numeral 10 relates to a fixture surrounding the light source entirely in the peripheral direction and thus being well suited to absorb the generated heat energy and in turn to dissipate it to the ambience.

The fixture 10 in turn is disposed in a socket 14 and for example screwed in. Thus a directed heat dissipation is possible by way of the fixture 10.

Reference numeral 20 refers to another cooling system or cooling device which in turn surrounds the socket 14.

FIG. 3 shows another embodiment of a lighting element according to the invention.

Unlike the embodiment shown in FIG. 2 the two connections 4 and 6 are incorporated in the fixture 10 and electric current is presently supplied via the socket 14. To this end it is possible for the socket itself to be bipartite or its left and right sides to be electrically insulated from one another.

The reference numerals 22 and 24 again relate to the electrical connections. The contacts 4 and 6 may presently be comprised of an electrically conductive plastic which, as indicated above, is supplied by the socket 14.

FIG. 4 shows another embodiment of a lighting element 1 according to the invention. Presently a plurality of light sources 2 is arranged in a row. Each of the fixtures 10 comprises outer walls 10a, 10b configured to complement one another so as to allow a specific mounting technique in this way. An area configuration of a lighting element 1 is achieved in this way.

Contacting can again occur via the electric contacts 22 and 24. As indicated above, the conductive tracks are printed, pressed on, laminated, or applied in a similar way. Or else it is conceivable for contacting of the light sources to occur directly via the outer walls 10a, 10b.

The invention allows to configure fixtures specifically tailored to be employed with LEDs. These increase the light yield by directed heat dissipation, enable smaller designs by way of fixtures adapted to the surrounding contour, and by way of the incorporated connection technology they provide added value in respect of handling and cost reduction. The entire fixture including the integrated LED can be performed with increased precision in a combined injection process.

Any and all features disclosed in the application documents are claimed as substantial to the invention as far as, taken individually or in combination, they are new over the prior art.

### LIST OF REFERENCE NUMERALS

1 lighting element
2 light source
2a section of light source
4 connection
6 connection
10 fixture
10a outer wall
10b outer wall
100 lighting element (prior art)
102 light source (prior art)
104 connection (prior art)
106 connection (prior art)
108 electrical connection
109 electrical connection
110 fixture (prior art)
114 socket (prior art)

1. A lighting element comprising: at least one light source, at least two connections to supply electric current to the light source and a fixture to receive the light source; the light source includes a heat-generating section and the fixture contacts said heat-generating section; wherein the fixture consists of a thermally conductive plastic and is configured such that it dissipates the heat generated by the light source at least in part.

2. The lighting element according to claim 1, wherein the light source is a light-emitting diode.

3. The lighting element according to claim 1, wherein the fixture surrounds the light source entirely in a peripheral direction.

4. The lighting element according to claim 1, wherein the lighting element comprises a socket surrounding the fixture.

5. The lighting element according to claim 1, wherein at least one connection comprises an electrically conductive plastic.

6. The lighting element according to claim 1, wherein the fixture consists of an electrically conductive plastic at least in part.

7. The lighting element according to claim 1, wherein the lighting element comprises another cooling device surrounding the fixture.

8. The lighting element according to claim 1, wherein the lighting element comprises printed conductive tracks.

9. The lighting element according to claim 1, wherein the lighting element comprises a plurality of light sources.

10. The lighting element according to claim 1, wherein the lighting element comprises a plurality of fixtures which can be joined together at their outer walls, wherein one first outer wall each comprises a first profile and one second outer wall each comprises a second profile and the first profile and the second profile are configured to complement one another.

11. A fixture for a light source, comprising: a receiving recess to receive a heat-generating section of the light source wherein the fixture consists of a thermally conductive plastic and is configured such that it dissipates the heat generated by the light source at least in part.
